(19) United States
(12) Patent Application Publication
(10) Pub. No.: US 2019/0377292 A1
(43) Pub. Date: Dec. 12, 2019

(54) FIXING DEVICE, IMAGE FORMING DEVICE, AND FIXING METHOD

(71) Applicant: Konica Minolta, Inc., Tokyo (JP)

(72) Inventors: Makoto FUJII, Tokyo (JP); Masahiro ONODERA, Tokyo (JP); Yasuo SHIRODAI, Tokyo (JP)

(21) Appl. No.: 16/406,745

(22) Filed: May 8, 2019

(30) Foreign Application Priority Data
Jun. 6, 2018 (JP) 2018-108219

(51) Int. Cl. G03G 15/20

(52) U.S. Cl. CPC G03G 15/2064; G03G 15/2028; G03G 2215/00945; G03G 2215/2038; G03G 2215/2045

(57) ABSTRACT

A fixing device fixes a toner image formed on paper, wherein a fixing member of which surface hardness of a surface opposed to an image surface of the paper is not higher than a predetermined Value is used, and a gloss level of the loner image is controlled by adjusting a speed of the paper or the fixing member to change a speed difference between the image surface of the paper and a surface of the fixing member.

The entire disclosure of Japanese patent Application No. 2018-108219, filed on Jun. 6, 2018, is incorporated herein by reference in its entirety.

### BACKGROUND

### Technological Field

The present invention, relates to a fixing device, an image forming, device, and a fixing method, and especially relates to a fixing device capable of controlling a gloss level, an image forming device including the fixing device, and an image forming method using the device.

### Description of the Related Art

An image forming device such as a copying machine or a multi-functional peripheral (MFP) which forms an image by using an electrophotographic method is formed of an image reading unit which reads an image from a document, an image processing unit which processes the read image, an image forming unit which prints the processed image on recording paper, a paper feeding unit which supplies the recording paper to the image forming unit and the like. The image forming unit is formed of a photoreceptor drum, a charging device which charges the photoreceptor drum, an exposure device which writes an electrostatic latent image on the photoreceptor drum, a developing device which visualizes the electrostatic latent image, a transfer unit which transfers a visible image on the photoreceptor drum onto an intermediate transfer belt and then transfers the same onto the recording paper via a secondary transfer roller, a fixing device which fixes the transferred image, a conveying unit which conveys the recording paper and the like.

Copying operation of the image forming device is briefly described; the document put on a document platen is scanned by an optical system of the image reading unit, and the document is read by an image sensor. A signal from the image sensor is sent to the image forming unit after predetermined image processing and the like is performed thereon by the image processing unit. In the image forming unit, an electrostatic latent image is formed by irradiating (exposing) the photoreceptor drum charged by the charging device with a laser beam on the basis of image data in the exposure device, this is visualized by the developing device, and thereafter this is sequentially transferred onto the intermediate transfer belt by the transfer unit to form a toner image. Then, the recording paper is fed by the conveying unit, conveyed to the transfer unit via a paper feed roller and a resist roller, and the toner image on the intermediate transfer belt is transferred onto the recording paper by the secondary transfer roller. Thereafter, the recording paper is heated and pressurized in the fixing device, and the transferred toner image is fixed to be output.

In the above-described image forming device, it is necessary to control the gloss level of the image in order to cope with optimum gloss of each paper and desired gloss of a user; as a method of controlling the gloss level by the fixing device, methods of (1) changing fixing temperature, (2) changing a fixing nip pressure, (3) changing a cooling speed after fixing and the like are known.

For example, JP 2005-250335 A discloses an image forming device including a fixing part that heats and fixes a toner image formed on a recording medium, and a near wax melting point rapid cooling part that rapidly cools from a high temperature side exceeding a melting point to a low temperature side lower than the melting point on the basis of the melting point of wax contained in the toner image.

Also, JP 2001-290382 A discloses an image gloss level adjusting device including a gloss applying member which comes into contact with an image formed on a sheet-like member capable of moving a contact surface with the image at least in a conveying direction of the sheet-like member, an opposing conveying member arranged so as to be opposed to the gloss applying member rotationally driven while bringing the sheet-like member into contact with the contact surface, a first driving part that moves the gloss applying member, and a second driving part that rotationally drives the opposing conveying member, in which the first driving part is provided so as to be able to move the contact surface at a moving speed V1 higher than a moving speed V2 of the surface.

Also, although this is not a technology of controlling the gloss level, regarding a phenomenon that wax exuded from the toner adheres to the fixing belt or the fixing roller, and a latent image formed by the adhered wax appears in a next image (gloss memory in which a portion with a small amount of adhesion and a portion with a large amount of adhesion generate gloss unevenness occurs), JP 2014-081610 A discloses a fixing device provided with a fixing surface side member rotatable provided and a rear surface side member which forms a fixing nip unit which nips and conveys the paper on which the toner image is formed in cooperation with the fixing surface side member while rotating in pressure contact with an outer peripheral surface of the fixing surface side member provided with a speed difference setting part that sets a speed difference between the surface speed of the rear surface side member and the surface speed of the fixing surface side member, the rear surface side member and the fixing surface side member rotating at a set speed difference.

However, the method (1) of changing the fixing temperature and the method (2) of changing the fixing nip pressure affect a fixing property, and a problem arises that the toner peels and that the color gamut is not formed, so that they may only be carried out under limited conditions. In addition, since cooling is performed in an extremely short time after the fixing, with the method (3) of changing the cooling speed after the fixing, there is a problem that it is difficult to realize a structure of efficiently cooling a necessary portion while preventing the fixing nip unit from being cooled, and it is difficult to obtain a large change in gloss level.

### SUMMARY

The present invention is achieved n view of the above-described problems, and a principal object thereof is to provide a fixing device, an image forming device, and a fixing method capable of controlling a gloss level at a low cost with a simple mechanism.

To achieve the abovementioned object, according to an aspect of the present invention, a fixing device reflecting one aspect of the present invention fixes a toner image formed on paper, wherein a fixing member of which surface hardness of a surface opposed to an image surface of the paper is not higher than a predetermined value is used, and a gloss level of the toner image is controlled by adjusting a speed of the paper or the fixing member to change a speed difference between the image surface of the paper and a surface of the fixing member.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention;

FIG. 1 is a cross-sectional view illustrating an overall configuration of an image forming device according to an example of the present invention;

FIGS. 2A to 2C are block diagrams illustrating a functional configuration of the image forming device according to an example of the present invention;

FIG. 3 is a schematic diagram illustrating a structure of a fixing device according to an example of the present invention;

FIG. 4 is a cross-sectional view illustrating a structure of a fixing belt of the fixing device according to au example of the present invention;

FIGS. 5A to 5C are measurement data illustrating a correlation between various types of hardness of the fixing belt according to an example of the present invention and a gloss level;

FIG. 6 is a table summarizing the measurement data in FIGS. 5A to 5C;

FIG. 7 is a schematic diagram for illustrating a driving method in belt fixing (lower roller driving) according to an example of the present invention;

FIG. 8 is a view illustrating a speed of each member in FIG. 7;

FIG. 9 is a schematic diagram for illustrating a driving method in belt fixing (upper and lower roller driving) according to an example of the present invention;

FIG. 10 is a view illustrating a change in gloss level in a case where a speed difference between upper and lower rollers in upper and lower roller driving according to an example of the present invention is changed;

FIG. 11 is a table illustrating a relationship between a gloss level setting value and an upper roller speed in the upper and lower roller driving according to an example of the present invention;

FIGS. 12A and 12B are examples in which a marker is added to an end of the belt in the fixing device according to an example of the present invention;

FIG. 13 is an example in which paper is measured by a paper passing sensor in the fixing device according to a example of the present invention;

FIG. 14 is a schematic diagram illustrating belt fixing using a pad according to an example of the present invention;

FIG. 15 is a schematic diagram illustrating a driving method (method of driving heating roller) in the belt fixing using the pad according to an example of the present invention;

FIG. 16 is an example in which a grip unit is provided on a heating roller in the belt fixing using the pad according to an example of the present invention;

FIG. 17 is an example in which the grip unit is provided on an inner surface of the heating belt in the belt fixing using the pad according to an example of the present invention;

FIG. 18 is a schematic diagram illustrating a driving method (method of adding belt end driving roller) in the belt fixing using the pad according to an example of the present invention; and

FIG. 19 is a schematic diagram illustrating a driving method (method of adding belt end driving roller) in the belt fixing using the pad according to an example of the present invention.

### DETAILED DESCRIPTION OF EMBODIMENTS

Hereinafter, one or more embodiments of the present invention will be described with reference to the drawings. However, the scope of the invention is not limited to the disclosed embodiments.

As described in the background art, in an image forming device, a process of funning an electrostatic latent image on a charged photoreceptor drum by irradiating (exposing) the same with a laser beam on the basis of image data, developing the electrostatic latent image to visualize, then sequentially transferring the same on an intermediate transfer belt to form a toner image, transferring the toner image on the intermediate transfer belt on recording paper by a secondary transfer roller, and heaing and pressurizing the same by a fixing device to fix the transferred toner image is performed.

In the above-described image forming device, it is necessary to control a gloss level of an image in order to cope with optimum gloss of each paper and desired gloss of a user; as a method of controlling the gloss level by the fixing device, methods of (1) changing fixing temperature (by increasing the fixing temperature, toner is sufficiently melt and the gloss level increases), (2) changing a fixing nip pressure (by increasing the fixing nip pressure, the toner is crushed and the gloss level increases), and (3) changing a cooling speed after fixing (by increasing the cooling speed, a particle becomes finer and the gloss level increases, for example, JP 2005-250335 A) are known,

However, the method (1) of changing fixing temperature or the method (2) of changing the fixing nip pressure affect a fixing property, and a problem arises that the toner peels due to insufficient fixing and that the color gamut is not formed because of insufficient mixture of the toner of respective colors, so that they may only be carried out under limited conditions. In addition, since cooling is performed in an extremely short time after the fixing, with the method (3) of changing the cooling speed after the fixing, it is difficult to realize a structure of efficiently cooling a necessary portion while preventing the fixing nip unit from being cooled, and it is difficult to obtain a large change in gloss level.

As another method, there is a method of increasing the gloss level by rubbing an image surface after the fixing; in JP 2001-290382 A, image gloss level;adjusting device is used, and an effect of increasing the gloss level by rotating an upper roller at a high speed in the vicinity of 75° C not lower than glass transient temperature and not higher than a melting point of the toner is obtained. However, when the image surface is rubbed by a fixing member at temperature not lower than melting temperature at a high speed at the time of fixing, disturbance occurs. Even if the temperature is lowered, if a speed difference between the image surface and a surface of the fixing member opposed to the image surface becomes too large, the image disturbance also occurs. Therefore, the speed difference cannot be increased and the gloss level cannot be sufficiently changed.

Therefore, in one embodiment of the present invention, focusing on a fact that hardness of the fixing member (especially, surface hardness of a fixing belt measured by a nanoindentation device) correlates with the gloss level, the hardness of the fixing member is lowered, a width of the change in gloss level with respect to the speed difference between the image surface and the surface of the fixing member opposed to the image surface is increased, so that the desired gloss level may be obtained while suppressing the occurrence of the image disturbance. Specifically, when the totter image formed on the paper is fixed, the fixing member in which the surface hardness of the surface opposed to the image surface of the paper is not higher than a predetermined value capable of increasing a change amount of the gloss level of the toner image with respect to the speed difference between the image surface of the paper and the surface of the fixing member (for example, indentation hardness (HIT) measured by a nanoindentation device is 3.5 N/mm² or lower) is used, and the speed of the paper or the fixing member is adjusted to change the speed difference between the image surface of the paper and the surface of the fixing member, thereby controlling the gloss level of the toner image.

In this manner, by controlling a slip between the image surface and the surface of the fixing member by using the fixing member the hardness of which (especially, the surface hardness measured by the nanoindentation device) is not higher than a predetermined value, the gloss level may be significantly changed, and it is possible to control the gloss level at a low cost with a simple mechanism.

### EXAMPLE

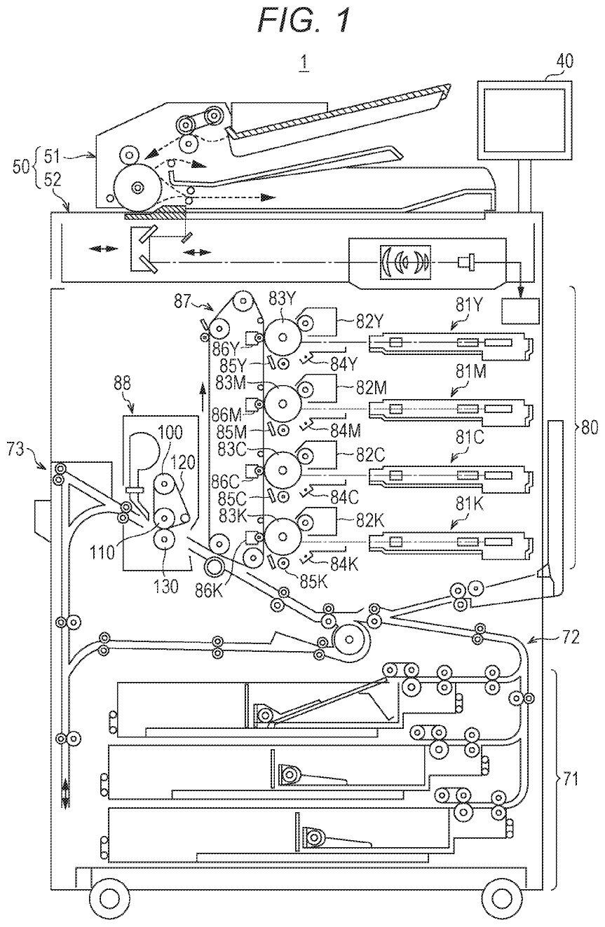

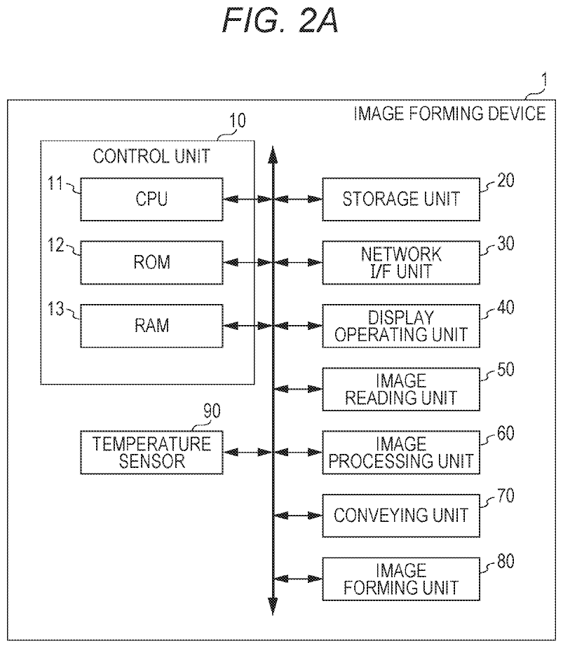

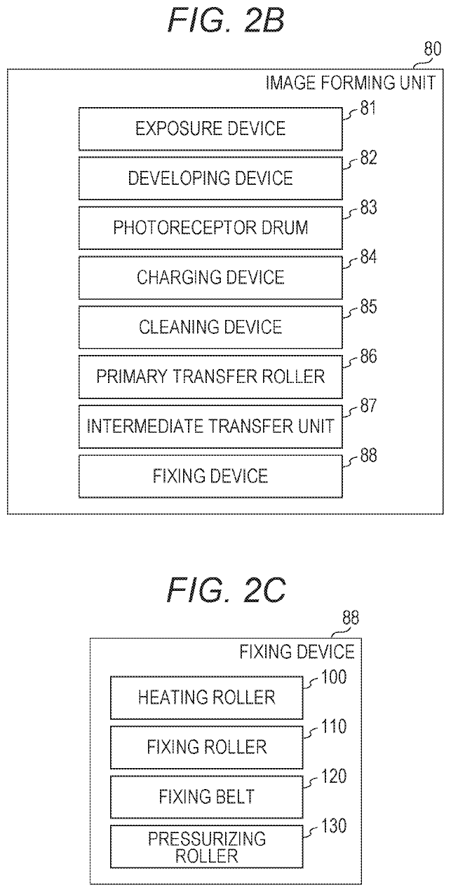

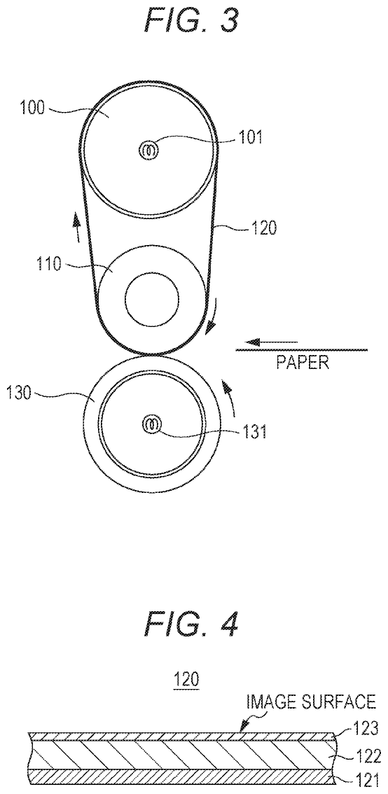

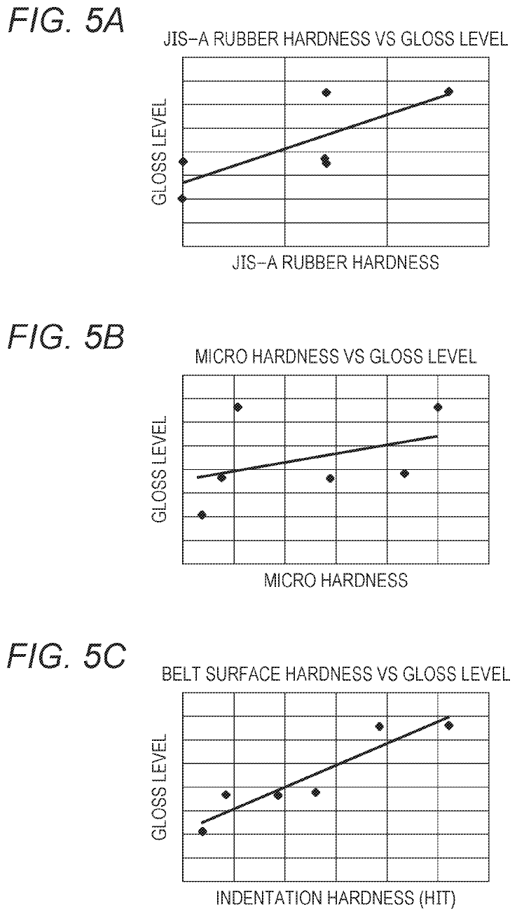

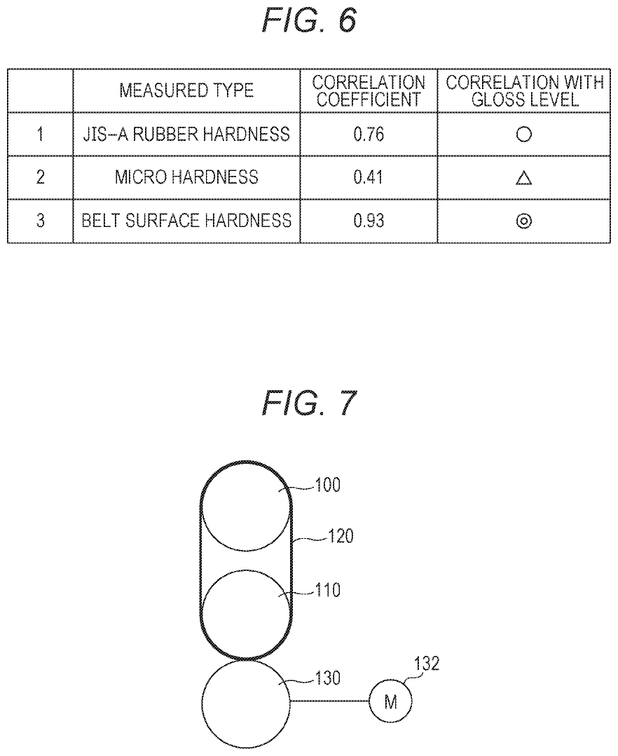

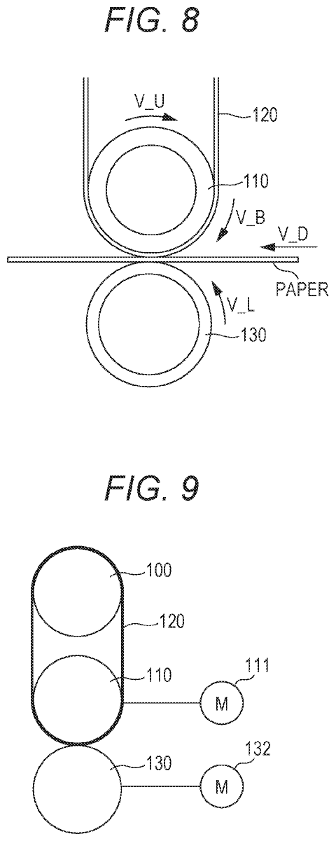

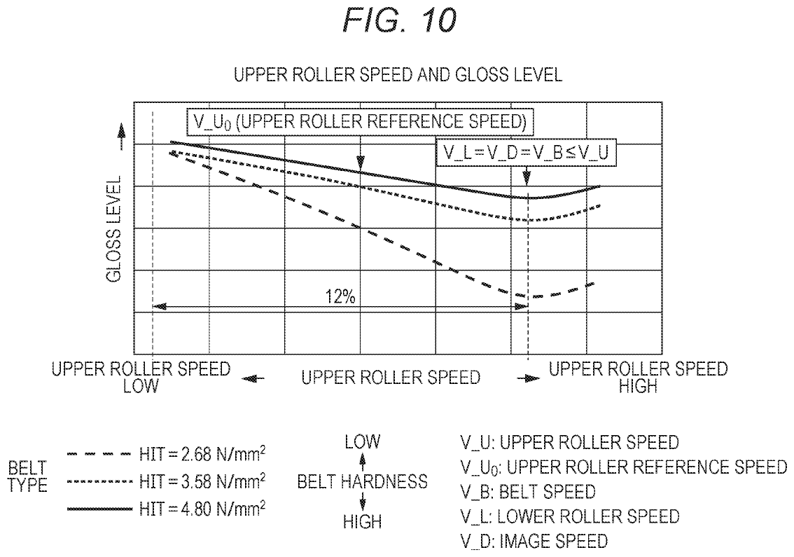

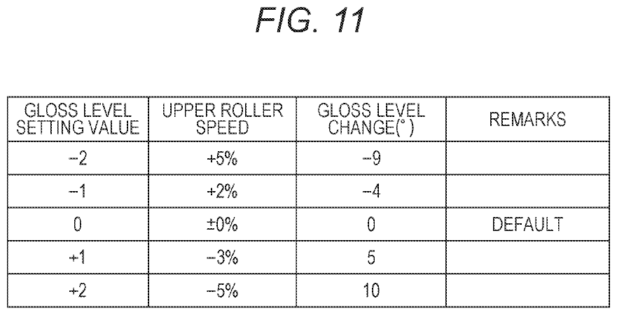

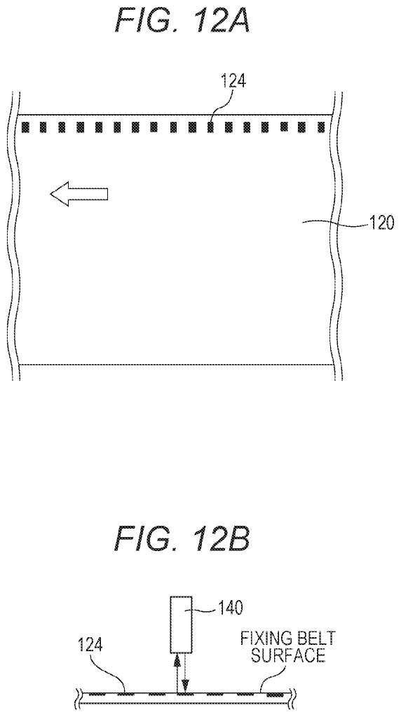

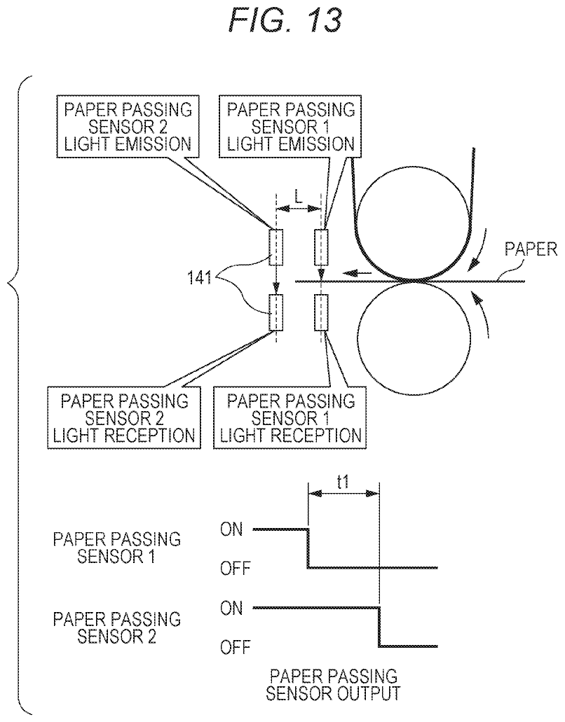

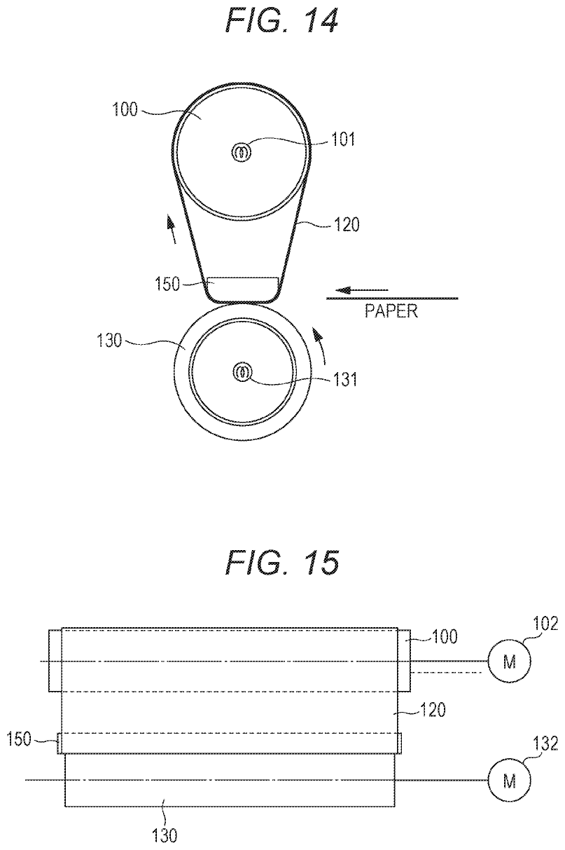

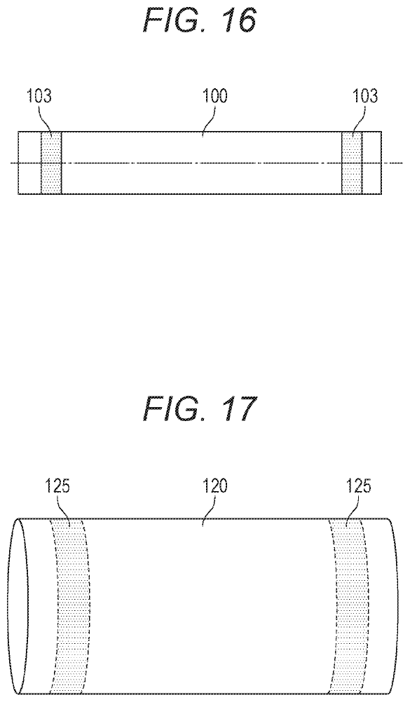

In order to describe one embodiment of the present invention described above in further detail, a fixing device, an image forming device, and a fixing method according to an example of the present invention are described with reference to FIGS. 1 to 19. FIG. 1 is a cross-sectional View illustrating an entire configuration of the image forming device of this example, and FIGS. 2A to 2C are block diagrams illustrating a functional configuration of the image forming device. FIG. 3 is a schematic diagram illustrating a structure of the fixing device of this example, and FIG. 4 is a cross-sectional view illustrating a structure of a fixing belt of the fixing device of this example. FIGS. 5A to 5C illustrate measurement data indicating, correlation between various types of hardness of the fixing belt and the gloss level, FIG. 6 is a table summarizing the measurement data, FIG. 7 is a schematic diagram for illustrating a caving method (lower roller driving) of belt fixing of this example, and FIG. 8 is a view illustrating a speed of each member. FIG. 9 is a schematic diagram for illustrating a driving method (upper and lower roller driving) of the belt fixing of this example, and FIG. 10 is a view illustrating a change in gloss level in a case where a speed difference between the upper and lower rollers is changed. FIG. 11 is a table illustrating a relationship between a gloss level setting value and an upper roller speed in the upper and lower roller driving, FIGS. 12A and 12B illustrate examples in which a marker is added to an end of the belt, and FIG. 13 illustrates an example in which paper is measured by a paper passing sensor. FIG. 14 is a schematic diagram for illustrating the belt fixing using a pad of this example, FIG. 15 is a schematic diagram for illustrating a driving method (method of driving a heating roller) in the ben fixing using the pad, and FIGS. 16 to FIG. 19 are views illustrating variations of the belt fixing using the pad.

As illustrated in FIG. 1, an image forming device 1 of this example forms an image by superimposing colors on the paper on the basis of image data obtained by reading a document, or image data input from an external information device (for example, client device) via a communication network. The image forming device 1 is a tandem-type image forming device in which photoreceptor drams 83Y, 83M, 83C and 83K as photoreceptors corresponding to four colors of yellow (Y), magenta (M), cyan (C), and black (K) are arranged in series in a travel direction of an object to be transferred (intermediate transfer belt), for example.

As illustrated in FIG. 2A, the image forming device 1 is formed of a control unit 10, a storage unit 20, a network I/F unit 30, a display operating unit 40, an image reading unit 50, an image processing unit 60, a conveying unit 70, an image forming unit 80, a temperature sensor 90 and the like.

The control unit 10 is formed of a central processing unit (CPU) 11 and a memory such as a read only memory (ROM) 12 and a random access memory (RAM) 13. The CPU 11 reads a program corresponding to a processing content from the ROM 12 or the storage unit 20 and develops the same on the RAM 13 to execute, thereby intensively controlling operation of each block (the display operating unit 40, the image reading unit 50, the image processing unit 60, the conveying unit 70, the image forming unit 80 and the like) of the image forming device 1. Especially, this controls such that the gloss level of the toner image becomes a desired value by adjusting a speed of the paper on which the toner image is formed or the fixing member opposed to the image surface of the paper to change the speed difference between the image surface of the paper and the surface of the fixing member.

The storage unit 20 formed of a hard disk drive (HDD), a solid state drive (SSD) and the like stores a props mi for the CPU 11 to control each unit, information regarding a processing function of the host device, the image data read by the image reading unit 50, image data input from a client device not illustrated or the like.

The network I/F unit 30 formed of a network interface card (NIC), a modem and the like connects the image forming device 1 to a communication network such as a local area network (LAN) or a wide area network (WAN and transmits and receives various data to and from an external information device. (for example, a client device).

The display operating unit 40 formed of a touch panel and the like obtained by providing a pressure-sensitive or a capacitive operating unit (touch sensor) on which transparent electrodes are arranged in a lattice pattern on a display unit such as a liquid crystal display (LCD) or an organic electro luminescence (EL) display serves as a display unit and an operating unit. The display unit displays various operation screens, image states, operation status of each function and the like according to a display control signal input from the control unit 10. The operating unit accepts various input operations by the user (for example, selecting operation of the gloss level setting, value and the like), and outputs the operation signal to the control unit 10.

The image reading unit 50 is formed of an automatic document feeding device 51 referred to as an auto document feeder (ADF), a document image scanning device (scanner) 52 and the like. The automatic document feeding device 51 conveys the document put on a document tray by a conveying mechanism and delivers the same to the document linage scanning device 52. The document image scanning device 52 optically scans the document conveyed from the automatic document feeding device 51 onto a contact glass or the document put on the contact glass, and forms an image of light reflected from the document onto a light receiving surface of a charge coupled device (CCD) sensor and reads the document image. The image (analog image signal) read by the image reading unit 50 is subjected to predetermined image processing by the image processing unit 60.

The image processing unit 60 is formed of a circuit which performs analog-to-digital (A/D) conversion processing, a circuit which performs digital image processing and the like. The image processing, unit 60 generates digital image data by performing the A/D conversion processing on the analog image signal from the image reading unit 50. The image processing unit 60 also analyzes a print job obtained from the external information device (for example, client device) and rasterizes each page of the document to generate digital image data. Then, the image processing unit 60 performs image processing such as color conversion processing, correction processing (shading correction or the like) according to initial setting or user setting, compression processing and the like on the image data as necessary, and outputs the image data after the image processing to the image forming unit 80.

The conveying unit 70 is formed of a paper feeding device 71, a conveying mechanism 72, a paper discharging device 73 and the like as illustrated in FIG. 1. In this example, the paper feeding device 71 is provided with three paper feed tray units. In the paper feed tray units, standard paper and special paper identified on the basis of a basis weight, size and the like of the paper are accommodated for each type set in advance. The paper accommodated in the paper feed tray unit is delivered one by one from an uppermost portion and conveyed to the image forming unit 80 by the conveying mechanism 72 provided with a plurality of conveying rollers such as a resist roller. At that time, tilt of the led paper is corrected and conveyance timing is adjusted by a resist unit in which the resist roller is arranged. Then, the paper on which the image is formed by the image forming unit 80 is discharged to a paper discharge tray outside the device by the paper discharging device 73 provided with a paper discharging roller.

The image forming unit 80 is provided with exposure devices 81 (81Y, 81M, 81C, and 81K), developing devices 82 (82Y, 82M, 82C, and 82K), photoreceptor drums 83 (83Y, 83M, 83C, and 83K), charging devices 84 (84Y, 84M, 84C, and 84K), cleaning devices 85 (85Y, 85M, 85C, and 85K), primary transfer rollers 86 (86Y, 86M, 86C, and 86K) provided so as to correspond to different color components Y, M, C, and K, respectively, an intermediate transfer unit 87, a fixing device 88 and the like as illustrated in FIGS. 1 and 2B. Note that, in the following description, signs without Y, M, C, and K are used as necessary.

The photoreceptor drum 83 of each of the color components Y, M, C, and K is an image carrier obtained by forming an organic photoreceptor layer (OPC) having an overcoat layer as a protective layer on an outer peripheral surface of a cylindrical metal base made of an aluminum material. The photoreceptor drum 83 is rotated in a counterclockwise direction in FIG. 1 following the intermediate transfer belt to be described later in a grounded state.

The charging device 84 of each of the color components Y, M, C, and K being a scorotron type is arranged in the vicinity of the corresponding photoreceptor drum 83 in a state in which a longitudinal direction thereof is along a rotational axis direction of the photoreceptor drum 83, and applies uniform potential to a surface of the photoreceptor drum 83 by corona discharge having the same polarity as that of the toner.

The exposure device 81 of each of the color components Y, M, C, and K scans in parallel with the rotational axis of the photoreceptor dram 83 by a polygon mirror and the like, for example, and forms an electrostatic latent image by performing image exposure on the basis of the image data on the surface of the uniformly charged corresponding photoreceptor dram 83.

The developing device 82 of each of the color components Y, M, C, and K accommodates a two component developer formed of toner of a small particle diameter of the corresponding color component and a magnetic material, and conveys the toner to the surface of the photoreceptor drum 83 and visualizes the electrostatic latent image carried by the photoreceptor drum 83 with the toner.

The primary transfer roller 86 of each of the color components Y, M, C, and K brings the intermediate transfer belt into pressure-contact with the photoreceptor drum 83, and primarily transfers the toner images of the respective colors formed on the corresponding photoreceptor drums 83 onto the intermediate transfer belt so as to be sequentially imposed.

The cleaning device 85 of each of the color components Y, M, C, and K recovers residual toner remaining on the corresponding photoreceptor drum 83 after the primary transfer. A lubricant applying mechanism not illustrated is provided adjacent to the cleaning device 85 on a downstream side in a rotating direction of the photoreceptor drum 83, and applies a lubricant to a photoreceptor surface of the corresponding photoreceptor drum 83.

The intermediate transfer unit 87 provided with an endless intermediate transfer belt being the object to be transferred, a supporting roller, a secondary transfer roller and the like is formed by stretching the intermediate transfer belt around a plurality of supporting rollers. When the intermediate transfer belt on which the toner images of the respective colors are primarily transferred by the primary transfer rollers 86Y, 86M, 86C, and 86K is brought into pressure-contact with the paper by the secondary transfer roller, the toner image is secondarily transferred onto the paper and delivered to the fixing device 88.

The fixing device 88 provided with a heating roller 100 as a heat source, a fixing roller 110 (also referred to as an upper roller in this example), a stretching member, a fixing belt 120 stretched around them, a pressurizing roller 130 (also referred to as a lower roller in this example) and the like as illustrated in FIGS. 1 and 2C heats and pressurizes the paper by the fixing belt 120 heated by the heating roller 100 and the respective rollers to fix the toner image not yet fixed formed on the paper. A detailed configuration of the fixing device 88 is to be described later,

Then, the paper on which the toner image is fixed by the fixing device 88 is discharged to the paper discharge tray outside the device by the paper discharging device 73 provided with a paper discharging roller.

The temperature sensor 90 being a sensor which measures temperature by thermoelectromotive force, change in electric resistance or magnetism, luminance, color, infrared intensity and the like arranged in each unit of the image forming device 1 (especially in the vicinity of the fixing belt 120 in this example), and outputs a signal corresponding to the temperature of each unit,

Next, the configuration of the fixing device 88 which is a characteristic part of this example is described in detail with reference to FIG. 3. FIG. 3 is a schematic diagram illustrating the configuration of the fixing device 88 (upper roller two-axis belt fixer).

The fixing device 88 of this example is, for example, a fixing device of a thermal belt type. In the fixing device 88 of the thermal belt type, a pressurizer is formed of an upper pressurizer in which the endless fixing belt 120 is stretched around the heating roller 100 and the fixing roller (upper roller) 110 and a lower pressurizer formed of the pressurizing roller (lower roller) 130. The fixing device 88 includes a fixing nip unit which nips and conveys the paper by the pressurizing roller 130 pressed against the fixing roller 110 via the fixing belt 120. That is, the fixing nip unit formed of the fixing belt 120 which is rotatably provided and the pressurizing roller 130 which rotates while being in pressure-contact with a surface (outer peripheral surface) of the fixing belt 121) nips and conveys the paper on which the toner image is formed in cooperation with the fixing roller 110.

The fixing belt 120 also serves as a heating unit which is brought into contact with the paper onto which the toner image is transferred and heats the paper at predetermined temperature. Herein, the predetermined temperature is temperature at which an amount of heat necessary for melting the toner may be supplied when the paper passes through the fixing nip unit, which varies depending on the paper type and the like of the paper on which the image is formed.

A temperature sensor 90 (not illustrated) which detects the temperature of the fixing belt 120 is arranged in the vicinity of the fixing belt 120, and a detection signal of the temperature sensor 90 is output to the control unit 10. The control unit 10 controls an output of a heater lamp 101 in the heating roller 100 (for example, controls to turn on/off the same) so that temperature measured by the temperature sensor 90 becomes temperature set in advance.

As illustrated in FIG. 4, the fixing belt 120 has a configuration obtained by sequentially stacking an elastic layer 122 formed of silicone rubber and the like having a thickness of approximately 220 μm, a surface layer 123 formed of fluorine-based resin or the like having a thickness of approximately 30 μm on an outer peripheral surface of a base material layer 121 formed of heat-resistive polyimide and the like having a thickness of approximately 70 μm, for example. The fluorine-based resin is a material containing any of perfluoroalkoxyalkane (PFA), polytetrafluoroethylene (PTFE), ethylene tetrafluoride/hexaftuoropropylene copolymer (FEP), and most preferably, any one of PFA, PTFE, and FEP. As a result, releasability of the surface of the fixing belt 120 to the toner resin and wax contained in the toner particle is also improved, and the toner hardly sticks to the surface of the fixing belt 120 at the time of fixing.

The stretching member (not illustrated) is arranged at a predetermined position apart from a position of the fixing nip unit between the fixing roller 110 and the pressurizing roller 130 via the fixing belt 120. This predetermined position is, for example, a position inclined at a predetermined angle from a perpendicular line of a straight line connecting end points of the fixing nip unit to an upstream side of the fixing nip unit. The stretching member is movably provided at this position, and tension of the fixing belt 120 is adjusted by movement of the stretching member. The tension of the fixing belt 120 may also be adjusted by fixing the stretching member and making the heating roller 100 movable.

The heating roller 100 heats the faxing belt 120 so that the paper nipped by the fixing nip unit is heated by the fixing belt 120 at predetermined temperature. The heating roller 100 has a configuration in which a resin layer made of PTFE and the like is formed on an outer peripheral surface of cylindrical core metal made of, for example, aluminum or the like.

The heating roller 100 incorporates the heater lamp 101 such as a halogen heater. Since an output of the healer lamp 101 is controlled by the control unit 10, the metal core and the resin layer are heated, and as a result, the fixing belt 120 is heated. Note that the fixing belt 120 may also be heated by electromagnetic induction heating (IH). In this case, a base of the fixing belt is formed of a material such as Ni capable of generating heat by electromagnetic induction.

The fixing roller (upper roller) 110 has a configuration in which an elastic layer made of silicon rubber and the like is formed on an outer peripheral surface of cylindrical core metal made of, for example, iron or the like. Furthermore, a surface releasing layer made of a fluorine based resin might be formed on an outer peripheral surface of the elastic layer. The fixing roller 110 is brought into pressure contact with the pressurizing roller 130 driven by a main driving source (motor) in the fixing device 88 via the fixing belt 120, so that this is rotatable following the same together with the fixing belt 120.

Also, the fixing roller 110 is subjected to driving control (for example, on/off of rotation, rotational speed, generation of braking force and auxiliary driving force and the like) by the control unit 10 via a torque generating unit not illustrated as necessary. For example, the torque generating unit includes motors M1 and M2 which rotationally drive the fixing roller 110 and a gear mechanism unit, and switches to set among “with braking”, “without braking”, and “constant torque rotation” as an action by the fixing roller 110 by individually switching the motors M1 and M2. Specifically, the torque generating unit performs pulse width modulation (PWM) control on the motors M1 and M2. The motors M1 and M2 individually apply predetermined torque to the fixing roller 110 via the gear mechanism unit not illustrated to generate the braking force or generate the auxiliary driving force on the fixing roller 110. For example, in order to generate the braking force for the rotation in a conveying direction (referred to as forward rotation) on the fixing roller 110 which rotates following the pressurizing roller 130, the motors M1 and M2 also apply torque rotating in the direction opposite to the forward rotation. The motors M1 and M2 apply torque to assist the fixing roller 110 rotating following the pressurizing roller 130 and generate the auxiliary driving force to rotate the fixing roller 110 in the same direction as the conveying direction.

The gear mechanism unit includes a plurality of gear groups which individually transmits the rotation of the motors M1 and M2 to the fixing roller 110. That is, this transmits only the torque of the motor M1 to the fixing roller 110, transmits only the torque of the motor M2 to the fixing roller 110, or combines the torque of both the motors M1 and M2 to transmit to the fixing roller 110 via these gears. As a result, the gear mechanism unit sets a speed difference between the rotational speed of the fixing roller 110 to which the torque is applied by driving of the motors M1 and M2 and the rotational speed of the pressurizing roller 130, and rotates them with the speed difference together with the motors M1 and M2.

The pressurizing roller (lower roller) 130 forms the pressurizer for forming the fixing nip unit together with the fixing roller 110. The pressurizing roller 130 is pressed against the fixing roller 110 via the fixing belt 120 by a fixing pressure switching mechanism not illustrated.

The pressurizing roller 130 is rotationally driven, by the motor, and the driving control (for example, on/off of rotation, rotational speed, pressure-contact/separation with/from the fixing roller 110 and the like) is performed by the control unit 10. Since other configurations of the pressurizing roller 130 are similar to those of the fixing roller 110, the description thereof is omitted. Note that a heater lamp 131 such as a halogen heater may be incorporated in the pressurizing roller 130.

The fixing pressure switching mechanism (not illustrated) includes a biasing part that biases the pressurizing roller 130 against the fixing roller 110. A configuration of the biasing part is not especially limited, and a known technology may be applied. The fixing pressure switching mechanism may switch a load when pro using the pressurizing roller 130 against the fixing roller 110 in multiple stages according to the paper type, basis weight, size and the like of the paper used for image formation. Driving control of the fixing pressure switching mechanism is performed by the control unit 10.

The fixing pressure switching mechanism also changes the position of the pressurizing roller 130. As a result, even in a case where the fixing roller 110 thermally expands due to an increase in surface temperature of the fixing belt 120 and an outer diameter thereof increases, the position of the pressurizing roller 130 and the position of the stretching member are changed correspondingly. As a result, the fixing nip unit may be moved to a suitable position.

Next, a relationship between the hardness of the fixing member in the fixing device 88 having the above-described configuration and the gloss level of the image after fixing is described.

It is known that the gloss level is correlated with the hardness of the fixing member (hardness of the fixing belt 120 in belt fixing, hereinafter referred to as belt hardness); it is possible to measure the belt hardness using various devices and an index indicating the belt hardness differs depending on the device. Therefore, in order to investigate the best index indicating the belt hardness, measurement of micro hardness and belt surface hardness in addition to JIS-A rubber hardness which is conventionally generally used as the index of the belt hardness was performed by using six types of fixing belts 120 including different surface layer 123, elastic layer 122, and base material layer 121.

The JIS-A rubber hardness is hardness measured by a measuring method in accordance with JIS K 6253, ISO 7619, ISO 868, ASTM D2240 and the like; a hardness measuring instrument (JIS-A hardness ester) was used as the measuring device. The JIS-A rubber hardness indicates the hardness of the rubber itself, and its value varies with change in shape after belt processing, so that the values of the six types of fixing belts 120 cannot be simply compared.

The micro hardness is hardness measured by reading with a detector an amount of displacement when a test piece surface is deformed by a spring via a pushing needle; a micro hardness measuring instrument (MD-1 Type A: manufactured by KOBUNSHI KEIKI CO., LTD.) was used as the measuring device. Although this micro hardness is widely used so far as the hardness of the belt, it is considered that the load at the time of measurement and a measurement range in a depth direction of the belt are large and this represents the hardness of roughly the outline belt.

The belt surface hardness is hardness measured by a measuring method in accordance with ISO 14577 or the like; this was measured by a nanoindentation device (ENT-1100a: manufactured by ELIONIX INC.) as the measuring device at an indentation pressure of 5 mN and heating at 170°C. This belt surface hardness represents the hardness in the vicinity of the belt surface (around several μm to several tens μm order). Note that, in this example, among several data representing the surface hardness, data of indentation hardness (indentation hardness: HIT) was used.

FIGS. 5A to 5C illustrate measurement data indicating a correlation between the belt hardness measured by the above-described three devices and the gloss level of the image fixed by using the fixing belt 120 having the belt hardness, and FIG. 6 illustrates a table in which the measurement data of FIGS. 5A to 5C are summarized. From FIGS. 5A to 5C and FIG. 6, it is found that the belt surface hardness (indentation hardness: HIT) measured by the nanoindentation device has the correlation with the gloss level the most. Therefore, in this example, the gloss level may be controlled appropriately by using the indentation hardness (HIT) as the hardness of the fixing member and defining a value of the indentation hardness (to be not higher than a predetermined value capable of increasing a change amount of the gloss level of the toner image with respect to the speed difference between the image surface of the paper and the surface of the fixing member).

Next, a relationship between the speed difference between the image surface and the surface of the fixing member opposed to the image surface and the gloss level is described. As illustrated in FIG. 7, in the driving method of the belt fixing, usually, the pressurizing roller (lower roller) 130 is driven by a motor 132 and the belt unit (heating roller 100, fixing roller (upper roller) 110, and fixing belt 120) is driven following the rotation of the lower roller. Herein, as illustrated in FIG. 8, the speed of each member is expressed as follows.

V_U: upper roller speed

V_B: belt speed

V_D: image speed

V_L: lower roller speed

In a case of lower roller driving, there is a speed relationship as follows.

V_L≥V_D≥V_B≥V_U (1)

Therefore, in a normal state of the lower roller driving, a slip occurs on the image surface and the belt surface.

Herein, in order to confirm how the gloss level changes due to the slip on the image surface and the belt surface, as illustrated in FIG. 9, the pressurizing roller (lower roller) 130 and the fixing roller (upper roller) 110 were independently driven by the motor 132 and a motor 111, respectively, and the speed difference between the upper and lower rollers was changed. Herein, three types of fixing belts 120 having different surface hardness were used, and the upper roller was driven such that the speed of the upper roller driven by the lower roller driving was set to be the speed around an upper roller reference speed (V_U₀ in the graph in FIG. 10, ±0% in the table in FIG. 11). That is, the driving of the upper roller was controlled by the control unit 10 using the above-described torque generating unit.

The change in gloss level at that time is illustrated in FIG. 10. From FIG. 10, the gloss level tends to gradually decrease as the upper roller speed is increased, become the lowest at a certain point (point of V_L=V_D=V_B≤V_U, and thereafter increase as the upper roller speed increases in any fixing belt 120. Also, in a belt having relatively low belt surface hardness, the effect (change amount of gloss level) of the speed difference between the upper and lower rollers on the gloss level was large, and in a belt having a relatively high belt surface hardness, the effect of the speed difference between the upper and lower rollers on the gloss level was small. Such a difference arises because, when the belt surface is hard, the melted toner is crushed along the belt surface, so that flatness of the image increases and the gloss level also increases, but when the surface is soft, unevenness of the melted toner remains, so that the flatness of the image decreases and the gloss level also does not increase.

In FIG. 10, at the point of V_L=V_D=V_B, there is no slip between the image surface and the belt surface, and the gloss level is the lowest at that point. Also, when the slip between the image surface and the belt surface becomes large, the image surface becomes flat due to the slip, so that the effect of the hardness of the belt is reduced and the gloss level is increased regardless of the belt hardness. According to this data, it is possible to widen a Variable range of the gloss level control by using the belt having lower belt surface hardness than the belt having high belt surface hardness.

Herein, although a recognition level of the gloss level change varies from person to person, it is considered that the change in gloss level of about 8° is required so as to be recognized as clear gloss level change. Therefore, as a result of examining the speed difference between the upper and lower rollers and the gloss level change, it was found that the gloss level change does not exceed 8° even when the speed difference between the upper and lower rollers was increased when the belt surface hardness became higher than 3.5 N/mm². Therefore, in order to control the gloss level, it may be said that it is preferable to set the range of the indentation hardness HIT of the belt surface hardness to 3.5 N/mm² or lower.

Actually, since the fixing belt 120 is driven by the upper roller, it becomes possible to increase the gloss level by setting the upper roller speed at which the speed difference between the belt speed and the lower roller speed becomes 0 as an upper limit value and decreasing the upper roller speed from the value. In a case of lowering the upper roller speed, a decrease within 12% from the upper limit value of the upper roller speed is a practical range, and when the upper roller speed is further decreased therefrom, side effects such as image distortion, deterioration in durability of the fixing member, and loss of synchronism of the motor occur easily.

Note that, although the indentation hardness HIT is used as the belt surface hardness in the above description, there is a correlation between the speed difference between the upper and lower rollers and the gloss level even with Martens hardness (HM), indentation elasticity modulus (EIT), pushing creep (CIT) and the like indicating other surface hardness as the HIT, so that an index indicating the surface hardness other than the HIT may also be used.

Next, an example of controlling the gloss level is described. As a method of controlling the gloss level, there are a method of performing on the basis of a table created in advance, and a method by measuring the speed of the fixing belt or the speed of the image surface and the speed of the fixing belt.

[Control by Table Value]

FIG. 11 illustrates an example of a table used when controlling the gloss level in which the upper roller speed in a state in which the upper roller of the fixing device 88 is not driven is set to ±0%. It becomes possible to control the gloss level of the image by selecting the gloss level setting value according to the optimum gloss of each paper and the desired gloss of the user, specifying the upper roller speed according to the selected gloss level setting value and controlling the torque generating unit by the control unit 10 to allow the upper roller to operate at the specified speed.

[Control by Measured Speed]

The gloss level is the lowest in a state in which the image surface and the belt surface do not slip and when the speed of the fixing belt 120 and the speed of the pressurizing roller (lower roller) 130 are the same. However, it is also conceivable that a slip state between the image surface and the belt surface changes due to long-term passage of paper or change with time of parts, so that it is preferable to actually measure the belt speed and the image surface (lower roller speed). Herein, although the fixing belt 120 is stretched around the fixing roller (upper roller) 110 and the heating roller 100, since the fixing belt 120 slips with each roller, it is required to directly measure the belt speed in order to grasp the belt speed.

For this purpose, it is possible to measure the belt speed by arranging a marker 124 in black and the like which does not reflect light at a predetermined interval on the end of the fixing belt 120 as illustrated in FIG. 12A, and reading the marker 124 by the optical sensor 140 as illustrated in FIG. 12B. Note that the marker 124 may he formed in dark color which does not reflect the light, but this may also be formed in white or by a mirror surface which reflects light on the contrary. Even an open hole may be read by the optical sensor 140.

In contrast, to measure the image surface is to measure the paper speed, so that it is possible to measure the paper speed by providing paper passing sensors 141 at two places in the paper passing direction in the vicinity of a portion where the paper passes through the fixing nip unit and measuring a difference in time (ti in the drawing) at which a tip end of the paper blocks sensor light as illustrated in FIG. 13. However, occurrence of meandering or rattling is inevitable when conveying the paper, and precision might be deteriorated, so that the lower roller speed may be measured instead of the paper speed.

Although the lower roller speed (surface speed) may be converted from the rotational speed of the pressurizing roller (lower roller) 130, the correlation between the rotational speed and the surface speed slightly changes due to a change in characteristic due to thermal expansion and change with time, it is preferable to accurately measure the surface speed of the lower roller. Measurement of the surface speed of the lower roller may also be realized by adding a marker for reading to the end and reading the moving speed of the marker with the optical sensor as in the case with belt measurement.

Note that, it is also possible to measure the surface speed by a laser Doppler speed meter as speed measurement. In a case where the speed of the fixing member is measured, it is possible to grasp the state in which there is no slip between the image surface and the belt surface, so that the point at which the gloss level is the lowest may be accurately specified. Furthermore, with the control based on the actually measured speed, since the gloss level may be controlled according to the actual state of the fixing, the control range is expanded, and more accurate gloss level control becomes possible.

Although the structure in which the fixing belt 120 is stretched between the heating roller 100 and the fixing roller (upper roller) 110 is described above, the present invention is also applicable to a structure using a pad instead of the fixing roller (upper roller) 110. FIG. 14 is a schematic diagram of the belt fixing using the pad at the position in which the fixing nip unit is formed.

In the case of belt fixing using a pad 150 as well, the gloss level changes depending on the slip state between the image surface and the belt surface, but since the driving force cannot be generated in the fixing belt 120 with the pad, in order to increase the belt speed, a structure of driving the fixing belt 120 by the heating roller 100 to add the driving force from an inner periphery of the belt, or a structure provided with a roller capable of driving the belt different from the lower roller at the end of the pressurizing roller (lower roller) 130 to add the driving force from an outer periphery of the belt is required.

[Structure of Applying Driving Force From Inner Periphery of Belt]

In FIG. 15, in the belt fixing using the pad 150, the fixing belt 120 is driven by driving the heating roller 100 by the motor 102. FIG. 16 is a view in which a grip unit 103 having high frictional force is provided at the end of the heating roller 100 so as to prevent the slip between the heating roller 100 and the fixing belt 120 when the fixing belt 120 is driven using the heating roller 100. Also, FIG. 17 is a view in which a grip unit 125 with high frictional force is provided on an inner surface (outside the image area) of the fixing belt 120 in order to improve the belt driving force of the heating roller 100.

[Structure of Applying Driving Force From Outer Periphery of Belt]

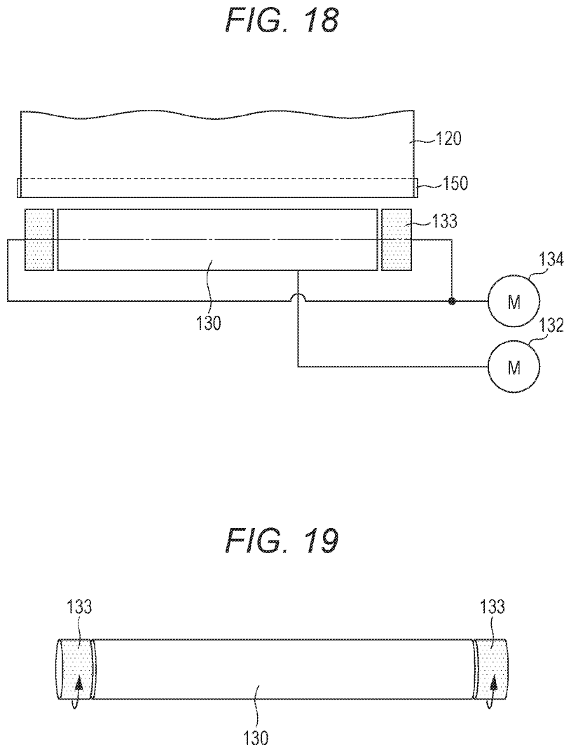

FIGS. 18 and 19 are views in which a belt end driving roller 133 is added at a position (not in contact with the paper) in contact with the fixing belt 120 at an end (preferably at both ends) of the pressurizing roller 130, and the belt end driving roller 133 is driven by the motor 134 in order to improve driving force of the fixing belt 120.

Note that, although an example in which the belt end driving roller 133 is added in the belt fixing is illustrated m FIGS. 18 and 19, a driving roller may be added in roller fixing without using the belt. However, in the roller fixing, the upper roller driving is generally performed, but unlike the lower roller driving in the case of the belt fixing, the fixing member in contact with the image surface has the driving force, so that the fixing member advances prior to the image surface. Therefore, in the case of the upper roller driving in the roller fixing and the like, since the fixing member is in a driving state with respect to the image surface, that is, in a state of assisting and slipping, it becomes possible to control the gloss level by adjusting the slip between the image surface and the fixing member by applying paper conveying force from below the paper.

As described above, focusing on the fact that the hardness of the fixing belt 120 (especially, the surface hardness measured by the nanoindentation device) is correlated with the gloss level, it is possible to significantly change the gloss level by using the fixing member the indentation hardness (HIT) of which measured by the nanoindentation device is 3.5 N/mm² or lower and adjusting the speed of the paper or the speed of the fixing member opposed to the image surface of the paper to change the speed difference between the image surface of the paper and the surface of the fixing member, thereby realizing the gloss level control at a low cost with a simple mechanism.

Note that the present invention is not limited to the above-described example, and the configuration and control thereof may be appropriately changed without departing from the gist of the present invention.

The present invention is applicable to the fixing device capable of controlling the gloss level, the image forming device including the fixing device, and the image forming method using the fixing device.

Although embodiments of the present invention have been described and illustrated in detail, the disclosed embodiments are made for purposes of illustration and example only and not limitation. The scope of the present invention should be interpreted by terms of the appended claims.

What is claimed is:

1. A fixing device that fixes a toner image formed on paper,
wherein a fixing member of which surface hardness of a surface opposed to an image surface of the paper is not higher than a predetermined value is used, and
a gloss level of the toner image is controlled by adjusting a speed of the paper or the fixing member to change a speed difference between the image surface of the paper and a surface of the fixing member.

2. The fixing device according to claim 1,
wherein a fixing member of which indentation hardness HIT measured by a nanoindentation device is 3.5 N/mm² or lower is used as the fixing member.

3. The fixing device according to claim 1,
wherein, in a case of belt fixing using a first pressurizer including a heating roller, a fixing roller, and a fixing belt stretched around the heating roller and the fixing roller, and a second pressurizer including a pressurizing roller opposed to the fixing roller via the fixing belt,
the fixing member is the fixing belt and a speed of the fixing belt is adjusted by controlling driving of the fixing roller.

4. The fixing device according to claim 1,
wherein, in a case of belt fixing using a first pressurizer including a heating roller, a pad, and a fixing belt stretched around the heating roller and the pad, and a second pressurizer including a pressurizing roller opposed to the pad via the fixing belt,
the fixing member the fixing belt and a speed of the fixing belt is adjusted by controlling driving of the heating roller.

5. The fixing device according to claim 1,
wherein, in a case of belt fixing using a first pressurizer including a heating roller, a pad, and a fixing belt stretched around the heating roller and the pad, and a second pressurizer including a pressurizing roller opposed to the pad via the fixing belt,
the fixing member is the fixing belt and a speed of the fixing belt is adjusted by controlling driving of a belt end driving roller provided in a position in contact with the fixing belt on an end of the pressurizing roller.

6. The fixing device according to claim 1,
wherein, in a case of roller fixing using a first pressurizer including a fixing roller, and a second pressurizer including a pressurizing roller opposed to the fixing roller,
the fixing member is the fixing roller and a speed of the paper is adjusted by controlling driving of the pressurizing roller.

7. The fixing device according to claim 3,
wherein a speed of the roller of which driving is controlled is set on the basis of the speed difference corresponding to the selected gloss level with reference to a table in which the gloss level is associated with the speed difference created in advance.

8. The fixing device according to claim 3,
wherein a speed of the roller of which driving is controlled is set on the basis of an actually measured value of the speed of the fixing belt, or the speed of the paper and the speed of the fixing belt.

9. An image forming device comprising:
the fixing device according to claim 1.

10. A fixing method in a fixing device that fixes a toner image formed on paper,
wherein a fixing member of which surface hardness of a surface opposed to an image surface of the paper is not higher than a predetermined value is used, and
a gloss level of the toner image is controlled by adjusting a speed of the paper or the fixing member to change a speed difference between the image surface of the paper and a surface of the fixing member.

11. The fixing method according to claim 10,
wherein a fixing member of which indentation hardness HIT measured by a nanoindentation device is 3.5 N/mm² or lower is used as the fixing member.

12. The fixing method according to claim 10,
wherein, in a case of belt fixing using a first pressurizer including a heating roller, a fixing roller, and a fixing belt stretched around the heating roller and the fixing roller, and a second pressurizer including a pressurizing roller opposed to the fixing roller via the fixing belt,
the fixing belt is the fixing member and a speed of the fixing belt is adjusted by controlling driving of the fixing roller.

13. The fixing method according to claim 10,
wherein, in a case of belt fixing using a first pressurizer including a heating roller, a pad, and a fixing belt stretched around the heating roller and the pad, and a second pressurizer including a pressurizing roller opposed to the pad via the fixing belt,
the fixing belt is the fixing member and a speed of the fixing belt is adjusted by controlling driving of the heating roller.

14. The fixing method according to claim 10,
wherein, in a case of belt fixing using a first pressurizer including a heating roller, a pad, and a fixing belt stretched around the heating roller and the pad, and a second pressurizer including a pressurizing roller opposed to the pad via the fixing belt,
the fixing belt is the fixing member and a speed of the fixing belt is adjusted by controlling driving of a belt end driving roller provided in a position in contact with the fixing belt on an end of the pressurizing roller.

15. The fixing method according to claim 10,
wherein, in a case of roller fixing using a first pressurizer including a fixing roller, and a second pressurizer including a pressurizing roller opposed to the fixing roller,
the fixing roller is the fixing member and a speed of the paper is adjusted by controlling driving of the pressurizing roller.

16. The fixing method according to claim 12,
wherein a speed of the roller of which driving is controller is set on the basis of the speed difference corresponding to the selected gloss level with reference to a table in which the gloss level is associated with the speed difference created in advance.

17. The fixing method according to claim 12,
wherein a speed of the roller of which driving is controlled is set on the basis of an actually measured value of the speed of the fixing belt, or the speed of the paper and the speed of the fixing belt.
